(19) United States
(12) Patent Application Publication
(10) Pub. No.: US 2004/0013511 A1
(43) Pub. Date: Jan. 22, 2004

(54) Method and device for preheating and draining steam supply lines connected to steam turbines

(76) Inventors: Eckart Brackenhammer, Effeltrich (DE); Michael Schottler, Erlangen (DE); Erich Schmid, Marloffstein (DE)

Correspondence Address: HARNESS, DICKEY & PIERCE, P.L.C., P.O.BOX 8910, RESTON, VA, 20195, US

(21) Appl. No.: 10/381,484

(22) PCT Filed: Sep. 14, 2001
(86) PCT No.: PCT/EP01/10665

(30) Foreign Application Priority Data
Sep. 26, 2000 (EP) 001209600

(51) Int. Cl. F03D 1/00

(52) U.S. Cl. 415/1; 415/116

(57) ABSTRACT

In order to improve a method for warming up steam feed lines (1, 2) connected to steam turbine stages (9, 10, 11), in which method warming-up steam is directed through a section to be warmed up of a first steam feed line and a second steam feed line, this warming-up steam being directed through the first steam feed line in an operating flow direction (4), existing during the turbine operation, of the steam, and in which warming-up steam is discharged through bypass lines of the steam feed lines, in such a way that reliable and quick warming-up and draining of the steam feed lines is made possible, the disposal systems merely being designed for lower capacities, the warming-up steam, after being directed through the section to be warmed up of the first steam feed line, must be directed through a connecting line (5) to the second steam feed line, this connecting line being open during the warming-up, must then be directed through the section to be warmed up of the second steam feed line against the operating flow direction (6), existing during the turbine operation, of the steam, and after that must be discharged through the bypass line (7) of the second steam feed line.

The invention relates to a method for warming up steam feed lines connected to steam turbine stages, in which method warming-up steam is directed through a respective section to be warmed up of a first steam feed line and a second steam feed line, this warming-up steam being directed through the first steam feed line in an operating flow direction, existing during the turbine operation, of the steam, and to a method for draining steam feed lines connected to steam turbine stages, in which method steam condensate from a first steam feed line and a second steam feed line is discharged through condensate discharge lines, and to an apparatus for draining and warming up steam feed lines connected to steam turbine stages, in which apparatus steam condensate from a first steam feed line and a second steam feed line can be discharged through condensate discharge lines, and in which the steam feed lines connected to steam turbine stages can be warmed up, in which warming-up steam can be directed through a section to be warmed up of a first steam feed line and a second steam feed line, which warming-up steam can be directed through the first steam feed line in an operating flow direction, existing during the turbine operation, of the steam.

In a steam power plant or a gas and steam power plant, superheated steam is fed through steam turbines, the rotors of which are set in motion by the temperature and pressure differences produced on account of the steam throughflow, as a result of which mechanical energy is produced. For better utilization of the superheated steam, a plurality of steam turbine stages are generally used, these steam turbine stages being designed for superheated steam having different temperatures and different pressures, i.e. high pressure, intermediate pressure and/or low pressure. Depending on the starting state of the downstream steam turbine, a certain steam state, in particular steam pressure, steam temperature and steam quality, i.e. steam purity before entry into the steam turbine, must be produced. To this end, in particular, steam feed lines, through which superheated steam is fed to the steam turbine stages during operation, are warmed up by means of heated warming-up steam before the steam turbines can be started up. The warming-up of the steam feed lines is effected either with the extraction lines provided for drainage or with separately installed warming-up lines through which the steam is discharged after passing through a steam feed line, for example into an atmospheric flash drum or to the turbine condenser. In this way, for each steam feed line, a large quantity of live steam has to be used for the warming-up and has to be subsequently condensed, for example, in the turbine condenser. The warming-up lines must have a very large capacity in order to keep the startup times of the steam turbine plant short. At the same time, the downstream disposal systems, in particular if the discharge is effected to the turbine condenser, also have to be designed for large steam quantities and at the same time have to be suitable for high steam temperatures in order to also permit a hot start of the steam turbines. In this case, especially reliable measures, in particular sufficient thermal and pressure protection, have to be taken for preventing any malfunctions.

In addition, draining has to be carried out during the startup of the water/steam circuit of the thermal power plant, i.e. the accumulating condensate which forms due to the heating of cold steam lines has to be removed from the steam systems in order to ensure reliable operation of the plant. To this end, the condensate is collected at low points of the steam lines and drawn off from the steam lines and directed, for example, into a startup flash drum. Water separated in the process is either rejected, that is to say removed from the circuit, or fed to the turbine condenser, to which the warming-up steam is also fed during the warming-up.

In this case, for example, the turbine condenser therefore has to perform a plurality of functions at the same time and in particular, on account of the steam fed, must be designed for very high temperatures or must be protected against them. However, these capacities to be provided are only rarely utilized completely and therefore entail large space and cost disadvantages.

The object of the present invention is therefore to specify a method for warming up/heating and draining steam feed lines connected to steam turbine stages and an apparatus for warming up and draining which permit reliable and quick warming-up and draining of the steam lines, in which case the disposal systems only have to be designed for lower capacities.

With regard to the method for warming up, the object is achieved in that the warming-up steam, after being directed through the section to be warmed up of the first steam feed line, is directed through a connecting line to the second steam feed line, this connecting line being open during the warming-up, is then directed through the section to be warmed up of the second steam feed line against the operating flow direction, existing during the turbine operation, of the steam, and after that is discharged through the bypass line of the second steam feed line.

If less steam passes into the disposal systems due to the repeated utilization of the warming-up steam, the capacity of the disposal systems can be designed to be smaller and the thermal load on the disposal systems is lower. Due to the reduced quantity of warming-up steam, the performance requirements to be met by the downstream disposal systems are reduced and simplified and therefore the systems can be constructed in a more cost-effective manner. This makes it possible to save warming-up steam during startup and at the same time ensure rapid heating of the steam feed lines. In addition, energy for the heating of the warming-up steam is saved. Furthermore, the possibility of malfunctions is minimized and the loss of warming-up steam during delivery to the atmosphere and the noise nuisance are also reduced with regard to the environmental compatibility of the plant.

These advantages are achieved by virtue of the fact that the warming-up steam, after flowing through the sections of the first steam feed line, flows through the connecting line to the second steam feed line and only then is discharged through the bypass line. The superheated steam is therefore used for both steam feed lines at the same time. The capacity of the connecting line and the capacity of the disposal systems are independent. The capacity of the connecting line is not affected by the limited capacity of the disposal systems. Depending on the capacity of the connecting line, a considerable reduction in the startup times of the steam turbine plant is possible. Disposal system parts of smaller size are thus possible. On account of the lower thermal loads, it is sufficient to use a less expensive material for the disposal system parts. The warming-up steam is not released into the atmosphere and discarded, as a result of which considerable environmental noise pollution is produced, but remains essentially in the circuit. As a result, the requirement for make-up water is also reduced. In this case, by the method according to the invention, especially critical line sections, through which the bypass steam would not flow during startup on account of the position of the connections of the bypass lines, can also be included in the warming-up.

Complete heating of the steam feed lines is achieved if the connecting line is in each case connected to an end close to the turbine of the sections of the first steam feed line which are to be warmed up and to an end close to the turbine of the sections of the second steam feed line which are to be warmed up. In this way, the superheated steam, on account of that end of the connecting line which is close to the turbine, flows through the first steam turbine feed line up to a point just upstream of the first steam turbine stage, then through the connecting line up to the end close to the turbine at the second steam feed line and from there in the opposite direction back through that section of the second line which is to be warmed up. Furthermore, additional lines are saved and the steam feed lines can be heated up to a point just upstream of the respective steam turbine stages.

It is advantageous if the first steam feed line is a high-pressure steam feed line to a high-pressure turbine stage and the second steam line is an intermediate-pressure steam feed line to an intermediate-pressure turbine stage or a low-pressure steam feed line to a low-pressure turbine stage. In this way, all the steam feed lines can be heated with the same warming-up steam of the high-pressure region. As a result, warming-up steam is saved and at the same time both steam feed lines are heated with the high-pressure warming-up steam having the higher temperature, where in the prior art only the steam feed lines to the high-pressure turbine stage are heated with the high-pressure warming-up steam. In this way, the intermediate-pressure feed line and the low-pressure feed line are heated to temperatures which are higher than normal and thus the difference from the operating state is substantially reduced. This is especially important in this region, since the temperature differences which otherwise occur here between the initial state and the superheated steam or reheated steam during operation are especially large. In triple-pressure gas and steam plants, the intermediate-pressure and the low-pressure steam feed lines can also be included given a correspondingly high temperature design. At the same time, any bypasses of the high-pressure steam feed line can be dimensioned for a smaller steam quantity. In an emergency overload of the turbine, the connecting line can be used for diverting steam and can also be utilized for a possible hot start as an additional discharge line for the superheated steam. In addition, it is not necessary to provide a direct connection from the high-pressure steam system to the disposal system, as a result of which, in the event of a malfunction, only a lower steam quantity, for example from the intermediate-pressure or low-pressure steam system, has to be expected and thus there is less risk for loading the condenser than in the case of the direct connection of the high-pressure steam line to the condenser if the disposal system is connected to the condenser.

If the warming-up steam is live steam, the warming-up is very effective, since the steam feed lines are then brought to a very high temperature level which is already close to the operating temperature.

The energy saving is very high if the first steam feed line is an intermediate-pressure steam feed line to an intermediate-pressure turbine stage and the second steam feed line is a low-pressure steam feed line to a low-pressure turbine stage. No separate steam feed to the intermediate-pressure steam line or to the low-pressure steam feed line need be effected, but rather the steam used for warming up the intermediate-pressure steam feed line system may likewise be used for the low-pressure steam feed line system.

Reheated steam may also be advantageously used as warming-up steam. After passing through the high-pressure steam system, this reheated steam is heated once again and reused. In this way, an additional energy saving and steam saving is achieved.

Intermediate storage of the warming-up steam is possible if the warming-up steam, after being directed through the section of the second steam feed line, is directed into a collecting vessel through the bypass line connected to the second steam feed line.

If the collecting vessel is a steam recovery plant, the steam used for the warming-up can be fed again to the water/steam circuit of the thermal power plant and need not be separated or released into the atmosphere, which would lead to energy losses and environmental pollution.

Cost-saving utilization of the already existing systems is provided if the steam recovery plant is a turbine condenser.

Very rapid and at the same time complete warming-up is achieved by live steam being introduced through the high-pressure steam feed line, and by reheated steam being introduced through the intermediate-pressure steam feed line, the live steam being directed through the connecting line and through the section of the intermediate-pressure steam feed line up to a connection point of the bypass line of the intermediate-pressure steam feed line, and the reheated steam being directed through a section of the intermediate-pressure feed steam line up to the connection point of the bypass line, and both steam flows being discharged through the bypass line. The reheated steam is therefore used for those parts of the intermediate-pressure steam feed line system which are not reached by the live steam and both steam flows are drawn off through the bypass.

Easy control of the warming-up operations and reliable separation of the high-pressure steam feed line and the intermediate-pressure steam feed line or the low-pressure steam feed line is achieved by the connecting line being opened by a motor-controlled valve for the warming-up. In this way, the warming-up can be controlled as required and a more or less large flow of warming-up steam can be set.

The object which relates to a method for draining steam feed lines connected to steam turbine stages is achieved by steam condensate being fed from the first steam feed line by means of a drainage connecting line via a flash vessel to the steam condensate from the second steam feed line and being discharged together with the steam condensate from the second steam feed line.

In this way, the loads for the downstream disposal systems are reduced. The steam condensate from the first steam feed line is first of all flashed and the water separated from the flash steam is then admixed. This reduces the possibility of malfunctions in the region of the steam condensate disposal of the first steam feed line. The downstream disposal systems may be designed to be smaller and the risk of malfunctions is reduced and at the same time rapid draining is effected.

The downstream disposal systems can be designed in a cost-effective manner with regard to their capacities and so as to be adapted to the requirements if the first steam feed line is a high-pressure steam feed line and the second steam feed line is an intermediate-pressure steam feed line or a low-pressure steam feed line. The draining of the high-pressure steam feed line need not be combined directly with an atmospheric flash drum or a turbine condenser in consideration of special safety provisions.

The set object is achieved by means of an apparatus for draining and warming up steam feed lines connected to steam turbine stages in that steam condensate can be fed from the first steam feed line via an intermediate-pressure level to the steam condensate from the second steam feed line and can be directed further together with the steam condensate from the second steam feed line, and the warming-up steam, after being directed through the section to be warmed up of the first steam feed line, can be directed through a connecting line open during the warming-up and can then be directed through the section to be warmed up of the second steam feed line against the operating flow direction, existing during the turbine operation, of the steam, and can then be drawn off through the bypass line of the second steam feed line to a disposal system. The warming-up function and the draining function are therefore independent of one another and the adjoining disposal systems for the warming-up steam, such as the turbine condenser, can be designed with lower capacities.

Exemplary embodiments of the invention are given in the figures. In the drawing:

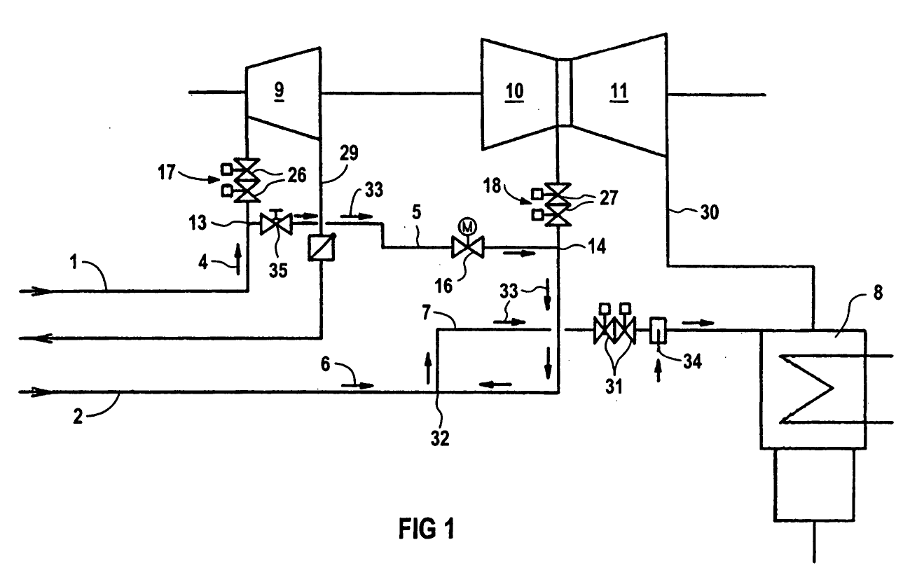

FIG. 1 shows an apparatus according to the method for warming up steam feed lines connected to steam turbine stages,

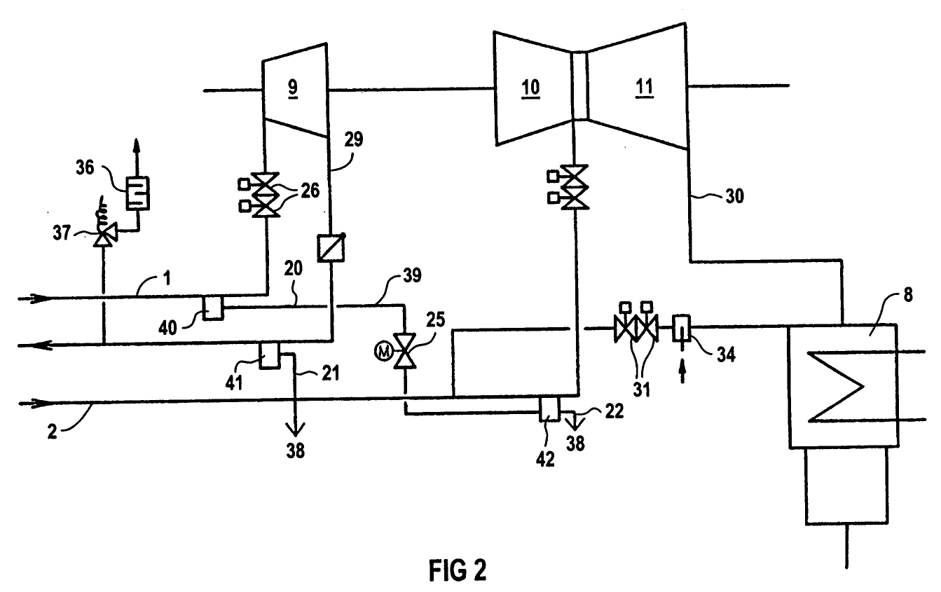

FIG. 2 shows an apparatus according to the method for draining steam feed lines connected to steam turbine stages, and

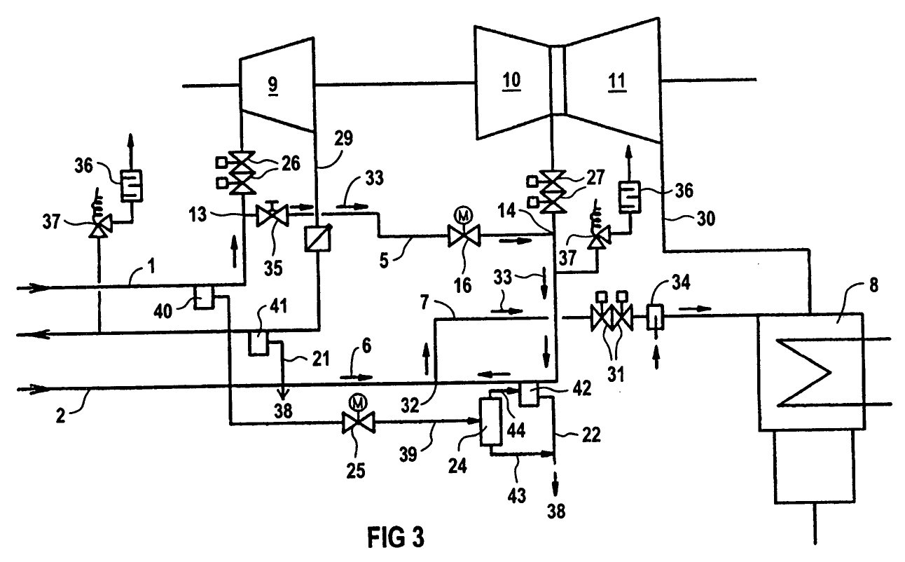

FIG. 3 shows an apparatus according to the method for draining and warming up steam feed lines connected to steam turbine stages.

FIG. 1 shows an apparatus according to the method for warming up steam feed lines connected to steam turbine stages. During normal turbine operation, superheated live steam is directed to a high-pressure turbine stage 9 through a high-pressure steam feed line 1 and is discharged again from the high-pressure turbine stage 9 through a high-pressure steam discharge line 29 and directed to a reheater (not shown) in which the cooled steam is reheated. This reheated steam is then directed to an intermediate-pressure turbine stage 10 through an intermediate-pressure steam feed line 2. The steam passes from the intermediate-pressure turbine stage 10 into a low-pressure turbine stage 11 and is then directed through a low-pressure steam discharge line 30 to a turbine condenser 8, which may be connected to a flash drum. The low-pressure turbine stage 11 may also have a separate low-pressure steam feed line, although this is not shown here. The steam is condensed in the turbine condenser 8 and passes in turn into the water/steam circuit of the thermal power plant. Upstream of the entry of the high-pressure steam feed line 1 into the high-pressure turbine stage 9, shut-off valves 26 are located on the high-pressure steam feed line 1 in order to be able to shut off the steam in the event of emergencies or when the steam flow through the high-pressure turbine stage 9 is to be cut off in a regulating manner. Likewise, the flow of the reheated steam into the intermediate-pressure turbine stage 10 can be prevented by shut-off valves 27 on the intermediate-pressure steam feed line 2 upstream of the intermediate-pressure turbine stage 10.

Before operation of the steam turbine, the high-pressure steam feed line 1 and the intermediate-pressure steam feed line 2 are warmed up. Before the warming-up, the shut-off valves 26 in the high-pressure steam feed line 1 and the shut-off valves 27 in the intermediate-pressure steam feed line 2 are closed and shut-off valves 31 in the bypass line 7 of the intermediate-pressure steam feed line 2 upstream of the turbine condenser 8 are opened. For the warming-up, warming-up steam in the form of live steam is directed in the operating flow direction 4 through the high-pressure steam feed line 1, through a connecting line 5 which leads from the high-pressure steam feed line 1 to the intermediate-pressure steam feed line 2, and then in the opposite direction to the operating flow direction 6 of the intermediate-pressure steam feed line 2 through the intermediate-pressure steam feed line 2 up to the connection point 32 of a bypass line 7 of the intermediate-pressure steam feed line 2. From there, the warming-up steam is directed through the bypass line 7 in the warming-up steam flow direction 33 up to the turbine condenser 8. The connection point 13 of the connecting line 5 at the high-pressure steam feed line 1 lies as close as possible to the end 17 near the turbine just upstream of the shut-off valves 26. The connection point 14 of the connecting line 5 at the intermediate-pressure steam feed line 2 in turn lies as close as possible to the shut-off valves 27 at the end 18 near the turbine of the intermediate-pressure steam feed line 2. In this way, the high-pressure steam feed line 1 and the intermediate-pressure steam feed line 2 are also warmed up completely in the critical ends 17, 18 near the turbine.

The warming-up of the remaining sections of the steam feed lines is effected by the throughflow of bypass steam, which passes through the steam feed lines in each case only up to the connections of the bypass lines which are connected to the steam feed lines. In this case, only the bypass line 7 of the intermediate-pressure steam feed line 2 is shown. The connecting line 5 is provided with a control valve 35 and a valve 16, which is possibly motor-controlled in order to be able to initiate and terminate the warming-up operations either by remote control or also by hand. The bypass line 7 also has cooling 34 between the shutoff valves 31 and the turbine condenser 8, this cooling 34 reducing the temperature of the steam passing through by the injection of water in order to prepare the condensing operations in the turbine condenser 8. As an alternative to directing the warming-up steam through the bypass line 7, the warming-up steam, by closing the shut-off valves 31 of the bypass line 7, may also be directed further through the intermediate-pressure steam feed line 2 against the operating flow direction 6 up to another tap, which is situated in such a way as to correspond to the requirements after complete warming-up of the intermediate-pressure steam feed line 2. The disposal system parts which are not shown are also, in particular, lances, flash drums and blow-off lines.

FIG. 2 shows an apparatus according to the method for draining steam feed lines connected to steam turbine stages. The draining preferably takes place before startup of the steam turbine in order to remove condensed waste water which may have collected from the individual steam feed lines or steam discharge lines. The steam condensates are collected at the low points 40, 41, 42 of the respective steam lines. Located between the low point 40 of the high-pressure steam feed line 1 and the low point 42 of the intermediate-pressure steam feed line 2 is a drainage connecting line 39, which can be opened by a valve 25, which is possibly motor-controlled. In this way, the condensate from the high-pressure steam feed line 1 can be fed to the condensate of the intermediate-pressure steam feed line 2 and the two condensate flows pass together into a separate disposal system 38, which works independently of the turbine condenser 8. The steam condensates from the low point 41 of the high-pressure steam discharge line 29 also pass into this disposal system 38 by means of a condensate discharge line 21. It is therefore not necessary for the turbine condenser 8, which is not loaded by the condensates, to be designed to be larger on account of the accumulating steam condensates. The condensate flows can be disposed of or reused independently of the warming-up steam for the steam feed lines. The dimensions of the respective disposal systems or condensers may be adapted to the specific requirements of the respective function and need not be oversized for any possible emergencies. In addition, the condensate and the warming-up steam have extremely different temperatures and pressures, so that greatly different requirements would have to be imposed on the respective disposal systems or condensers, and these requirements would have to be met by one system alone given common disposal of the steam or condensate. This oversized design of the system is prevented by the method and apparatuses according to the invention.

FIG. 3 shows the combined use of warming-up function and condensate discharge. The condensate drawn off from the low point 40 of the high-pressure steam feed line 1 is connected via a drainage connecting line 39 to a flash drum 24. The flash drum 24 has an outlet 44 which leads to a low point 42 of the intermediate-pressure steam feed line 2 and an outlet 43 which leads to a condensate discharge line 22 of the low point 42 of the intermediate-pressure steam feed line 2. The discharge line 21 leads in turn to a disposal system 38, in which the two condensate flows are disposed of together or are returned into the water/steam circuit. The draining of the high-pressure steam feed line 1 is therefore effected by an interposed intermediate level, a flash drum in the form of a stand pipe connected upstream.

The warming-up function and the draining function may be turned on and off independently of one another, for example by the motor-controlled valves 16 and 25, respectively. To prevent any overloads, and, inter alia, because a high-pressure system is connected to an intermediate-pressure system, units for the delivery of steam to the atmosphere are provided in the high-pressure steam drain line 29 and in the intermediate-pressure steam feed line 2, respectively, these units having a pressure relief valve 37 and a silencer 36. The blow-off lines of these pressure relief valves 37 in the high-pressure steam discharge line 29 and the intermediate-pressure steam feed line 2 may be connected to one another in order to utilize a common silencer.

1. A method for warming up steam feed lines (1, 2) connected to steam turbine stages (9, 10, 11), in which method warming-up steam is directed through a respective section to be warmed up of a first steam feed line (1) and a second steam feed line (2), this warming-up steam being directed through the first steam feed line (1) in an operating flow direction (4), existing during the turbine operation, of the steam, and in which warming-up steam is discharged through a bypass line of a steam feed line, wherein the warming-up steam, after being directed through the section to be warmed up of the first steam feed line (1), is directed through a connecting line (5) to the second steam feed line (1), this connecting line (5) being open during the warming-up, is then directed through the section to be warmed up of the second steam feed line (2) against the operating flow direction (6), existing during the turbine operation, of the steam, and after that is discharged through the bypass line (7) of the second steam feed line (2).

2. The method as claimed in claim 1, wherein the connecting line (5) is in each case connected to an end (17) close to the turbine of the sections of the first steam feed line which are to be warmed up and to an end (18) close to the turbine of the sections of the second steam feed line which are to be warmed up.

3. The method as claimed in either of claims 1 and 2, wherein the first steam feed line is a high-pressure steam feed line (1) to a high-pressure turbine stage (9) and the second steam line is an intermediate-pressure steam feed line (2) to an intermediate-pressure turbine stage (10) or a low-pressure steam feed line to a low-pressure turbine stage (11).

4. The method as claimed in one of claims 1 to 3, wherein the warming-up steam is live steam.

5. The method as claimed in one of claims 1 to 4, wherein the first steam feed line is an intermediate-pressure steam feed line (2) to an intermediate-pressure turbine stage (10) and the second steam feed line is a low-pressure steam feed line to a low-pressure turbine stage (11).

6. The method as claimed in one of claims 1 to 5, wherein the warming-up steam is reheated steam.

7. The method as claimed in one of claims 1 to 6, wherein the warming-up steam, after being directed through the section of the second steam feed line, is directed into a collecting vessel (8) through the bypass line (7) connected to the second steam feed line.

8. The method as claimed in one of claims 1 to 7, wherein the collecting vessel (8) is a steam recovery plant.

9. The method as claimed in one of claims 1 to 8, wherein the steam recovery plant is a turbine condenser (8).

10. The method as claimed in one of claims 1 to 9, wherein live steam is introduced through the high-pressure steam feed line (1), and reheated steam is introduced through the intermediate-pressure steam feed line (2), the live steam being directed through the connecting line (5) and through the section (12) of the intermediate-pressure steam feed line (2) up to a connection point (32) of the bypass line (7) of the intermediate-pressure steam feed line (2), and the reheated steam being directed through a section (15) of the intermediate-pressure feed steam line (2) up to the connection point (32) of the bypass line (7) of the intermediate-pressure steam feed line (2), and both steam flows being discharged through the bypass line (7).

11. The method as claimed in one of claims 1 to 10, wherein the connecting line (5) is opened by a motor-controlled valve (16) for the warming-up.

12. A method of draining steam feed lines (1, 2) connected to steam turbine stages (9, 10, 11), in which method steam condensate from a first and a second steam feed line is discharged through condensate discharge lines, in particular as claimed in one of claims 1 to 11, wherein steam condensate is fed from the first steam feed line by means of a drainage connecting line (39) via an intermediate-pressure level to the steam condensate from the second steam feed line and is discharged together with the steam condensate from the second steam feed line.

13. The method as claimed in claim 12, wherein the intermediate-pressure level is a flash drum (24).

14. The method as claimed in claim 12 or 13, wherein the steam feed line is a high-pressure steam feed line (1) and the second steam feed line is an intermediate-pressure steam feed line (2) or a low-pressure steam feed line (3).

15. An apparatus for draining and warming up steam feed lines (1, 2, 3) connected to steam turbine stages (9, 10, 11), in which apparatus steam condensate from a first steam feed line and a second steam feed line can be discharged through condensate discharge lines, and in which the steam feed lines (1, 2, 3) connected to steam turbine stages (9, 10, 11) can be warmed up, in which warming-up steam can be directed through a section to be warmed up of a first steam feed line and a second steam feed line, which warming-up steam can be directed through the first steam feed line in an operating flow direction, existing during the turbine operation, of the steam, in particular for carrying out the method as claimed in one of the preceding claims, wherein steam condensate can be fed from the first steam feed line via an intermediate-pressure level to the steam condensate from the second steam feed line and can be directed further together with the steam condensate from the second steam feed line, and the warming-up steam, after being directed through the section to be warmed up of the first steam feed line, can be directed through a connecting line (5) open during the warming-up and can then be directed through the section to be warmed up of the second steam feed line against the operating flow direction, existing during the turbine operation, of the steam.
